(19) United States
(12) Patent Application Publication
(10) Pub. No.: US 2008/0065857 A1
(43) Pub. Date: Mar. 13, 2008

(54) Method for the Permanent Storage of Subscriber Data

(75) Inventor: Stephan Binde, Baierbrunn (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 11/664,744

(22) PCT Filed: Sep. 24, 2005
(86) PCT No.: PCT/EP05/10354

§ 371 Date: Apr. 5, 2007

(30) Foreign Application Priority Data
Nov. 11, 2004 (EP) 04026792.4

(51) Int. Cl. G06F 9/26

(52) U.S. Cl. 711/211; 711/E12.001

(57) ABSTRACT

In a method of saving subscriber data from a connection multiplexer in a restart-resistant manner, the data is stored in one subscriber connection data record per subscriber, and contains an electronic address and a period of validity. The subscriber connection data records are stored in a restart-resistant memory, wherein a subscriber connection data record further includes an index identifying the subscriber concerned. After a restart of the connection multiplexer the subscriber data is reconstructed by determining a number of subscriber data sets and thereby an occupancy of the restart-resistant memory, and allocating individual subscribers arranged in linear fashion to their corresponding stored data sets with the aid of the index which is stored in a table and identifies each of the subscribers concerned.

The invention relates to a method for saving subscriber data in a restart-resistant manner according to the pre-characterizing clause of claim 1.

From here on the specific technical terms and conventional acronyms for the telecommunication areas known as access technology (or simply “access”), transport (or “core network”) and Internet protocol will be used in order to explain the subject matter concisely and accurately. These acronyms are listed at the end as an integral part of this document. In most cases therefore, no special explanation of the said terms and acronyms will be given in the course of the text. Moreover when used in the telecommunication sense, and therefore in the context of this document, the term “subscriber” does not refer to a person.

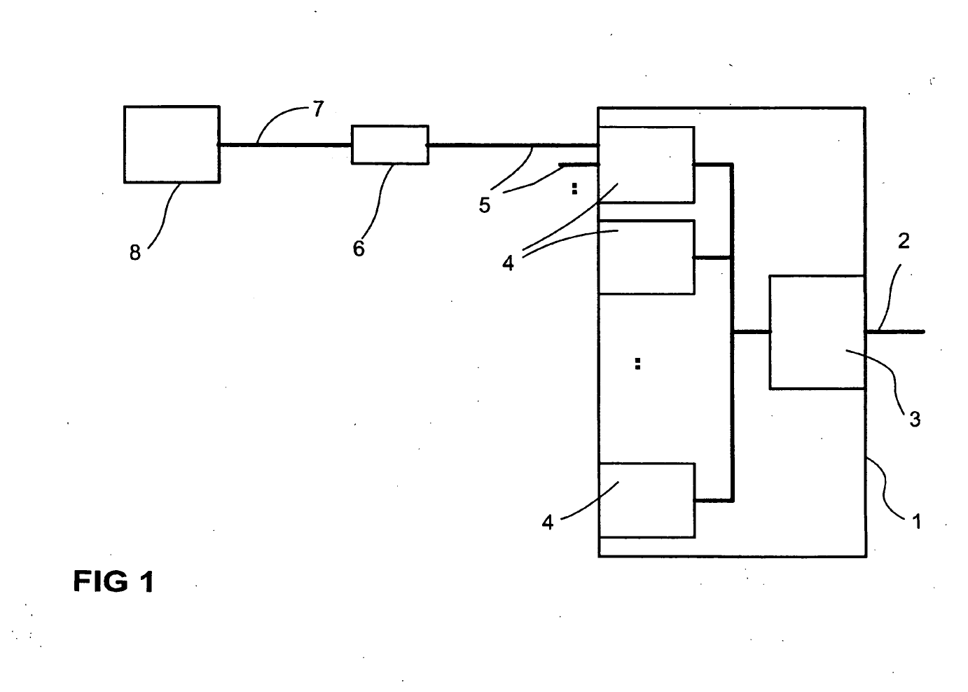

The transmission mode known as xDSL is used for high bit-rate access to the subscriber. In this mode a plurality of ADSL or xDSL modems ATU-R are connected to a multiplexer DSLAM from the connection point of a telecommunications operator. FIG. 1 shows the typical way of connecting an xDSL access to a telecommunications network. An ADSL modem is characterized by the generic term ATU-R. Communication at levels higher than the transport layer uses the Internet protocol IP.

In order to communicate, a client computer (subscriber-side) needs an IP address. In most cases an IP address is dynamically allocated from a pool for a certain time using DHCP protocol. The operator frequently sets the validity of this address at less than 24 hours. This is done for two reasons:
i) The subscriber-side client computer cannot then be used as the host for a Web application,
ii) This method permits the limited resource pool IP address space to be better used.

Reference will now be made to FIG. 1 for the purpose of giving further explanation. A client computer 8 is connected over an xDSL path 5 to a server (not shown in FIG. 1) via a DSLAM 1. As explained in the introduction, an IP address is allocated to the client computer 8 for a limited time known as the “lease time”. Only this client computer 8 is authorized to exchange data in the Internet with this IP address. The task of the DSLAM 1 is to combine the subscribers 8 into a bundle and route the data traffic to a server. For the purpose of reliability and better subscriber administration, said device should have access to the communication between the server and the subscribers. The DHCP protocol has therefore been introduced as a relay according to RFC 3046. As a relay station the DSLAM 1 is thus given access to the transmitted data packets and can save the IP address, MAC address and lease time in a data field allocated to the subscriber. By this means the data path for the subscriber concerned can be enabled or disabled as often as necessary and it also makes billing possible in appropriate cases. The DHCP protocol does not include a “keep alive” mechanism for continuously refreshing the data. As already mentioned, the address is allocated at the start. The said data relating to the IP address, MAC address and lease time should therefore be stored particularly securely in order that there is no loss of synchronization between the DSLAM 1 and the subscribers 8. A loss of data would consequently result in the communication path between the client computer 1 and the server being disabled. The client computer 1 would in fact still have a valid IP address and from the viewpoint of the client there is therefore no cause to request a new IP address. Short interruptions occur intentionally or unintentionally in the DSLAM 1, accompanied as a rule by a loss of dynamic data. A short interruption is intentional in particular when the security technology causes a restart of the DSLAM 1 on grounds of inconsistency.

The problem that therefore arises is how to store the subscriber-related IP address, MAC address and lease time data in a restart-resistant memory and quickly reconstruct said data in a simple manner.

This problem can be solved by the following alternative approaches:

A Searching for data in a memory field;

B Storing fixed data in restart-resistant memories.

Approach A

Subscriber data such as MAC address, subscriber index, etc. are stored in a memory module and retrieved using a fast access method. For this purpose there are machine-intimate solutions such as CAM components, which are designed for fast search accesses so that when a search term is entered (such as subscriber index) they return the required data set (e.g. MAC address). In principle this method can also be used as a software solution. For this purpose it is always necessary to re-store the data in the CAM component each time there is a new entry. Furthermore in most cases CAM components are not restart-resistant.

Approach B

B.1 WO 2004./038979 A2

Document WO 2004/038979 A2 [2] proposes a passive optical network PON for restoring an address allocation in which said address allocation is stored in a non-volatile memory and the original state is restored by means of appropriate queries.

B.2 EP 1 260 907 A1

Document EP 1 260 907 A1 [1] discloses a method for persistent storing of data in which parts of the operating system are copied from a Flash PROM read-only memory into the read-write memory during power-up. The Flash PROM read-only memory can be provided with a new version of the said operating system parts afterwards if need be. Flash PROM read-only memories are restart-resistant, but rewriting is possible only after deletion block-by-block. For this reason this technique cannot be used for the problem mentioned above. In the context of this document the term “restart-resistant” is synonymous with the term “new-start resistant”.

The object of the present invention is therefore to specify a method for saving in a restart-resistant manner the subscriber data of subscribers connected to a connection multiplexer so that subscriber data can be obtained when a connection multiplexer is restarted and after the restart said data can be allocated in a simple manner to the subscribers of the said connection multiplexer and the data can be reconstructed.

This object is achieved by means of the method specified in claim 1. Advantageous embodiments of the invention are specified in further claims.

The inventive method permits the reconstruction of the dynamic data in a simple manner when a connection multiplexer has been restarted, without said data having to be re-stored. This is achieved by a restart-resistant memory that contains the subscriber connection data records and additionally by the storage of an index for each subscriber connection data record, said index identifying the relevant subscriber.

In this way a method is provided for saving and reconstructing the vitally important subscriber connection data. At this point it should be noted that in the context of this document the terms saving, back-up and data back-up subsume not only the storage but also the reconstruction of the data (or subscriber data). This is also how the concept is understood colloquially, since the term data back-up always implies that the data can also be restored to the original location.

The invention will be explained in greater detail with the aid of the accompanying drawing and figures. These show the following:

FIG. 1 Connection of the ADSL subscriber to a telecommunications infrastructure;

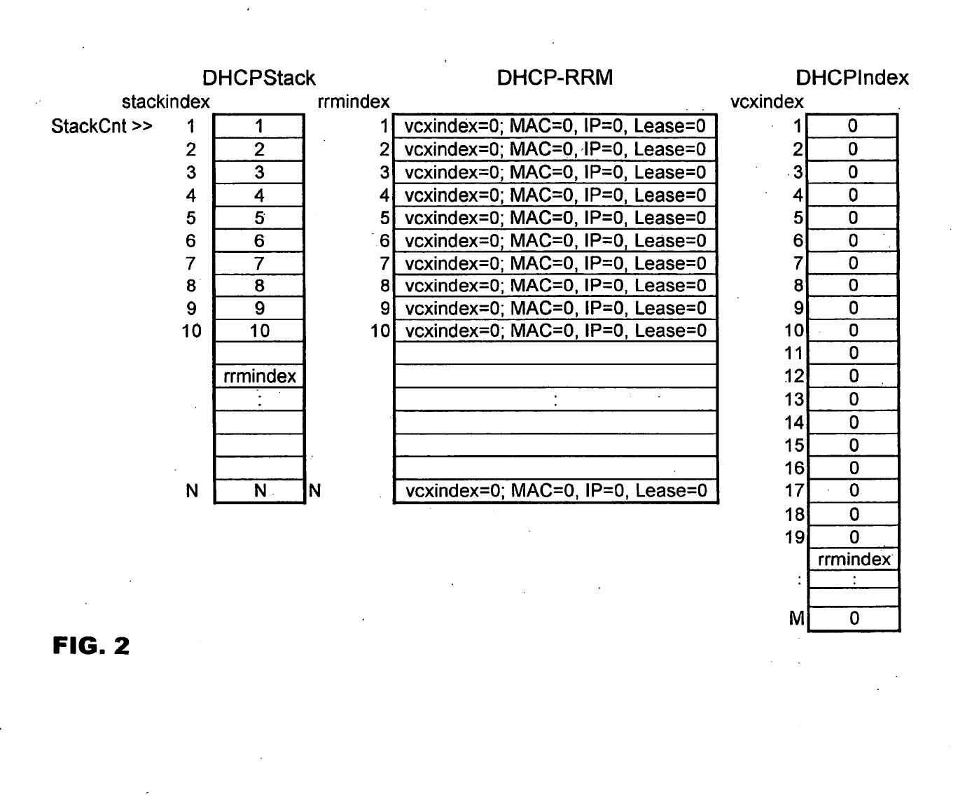

FIG. 2 Initial state of a data structure with subscriber data (yet to be added);

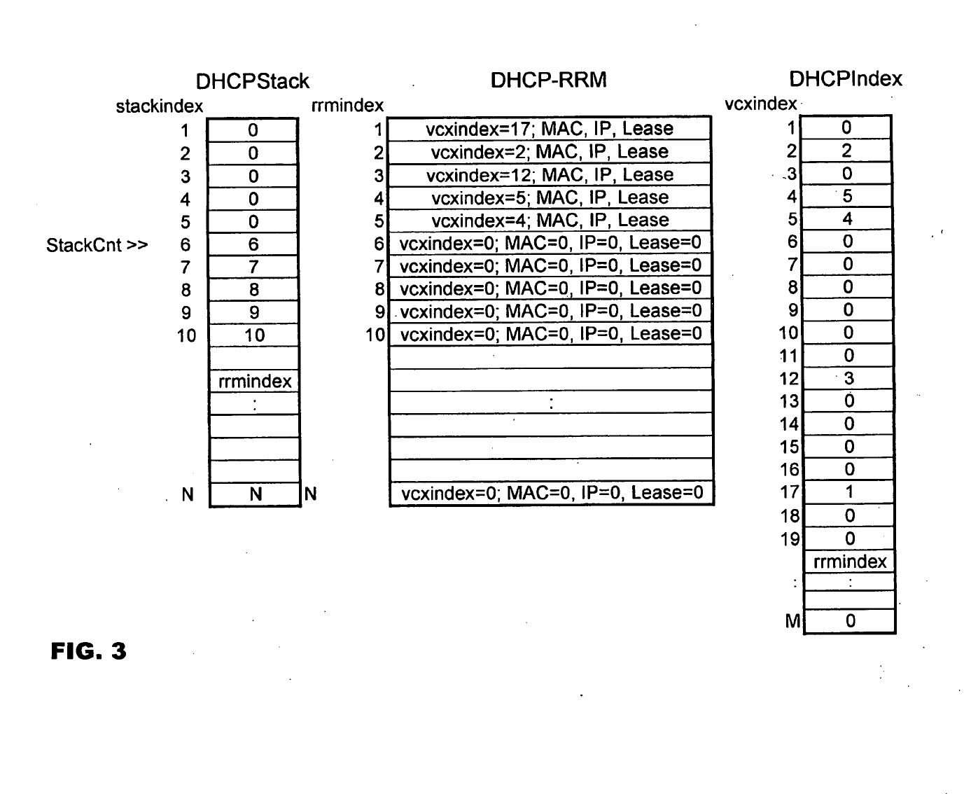

FIG. 3 State of a data structure with subscriber data on the insertion of a new subscriber data set;

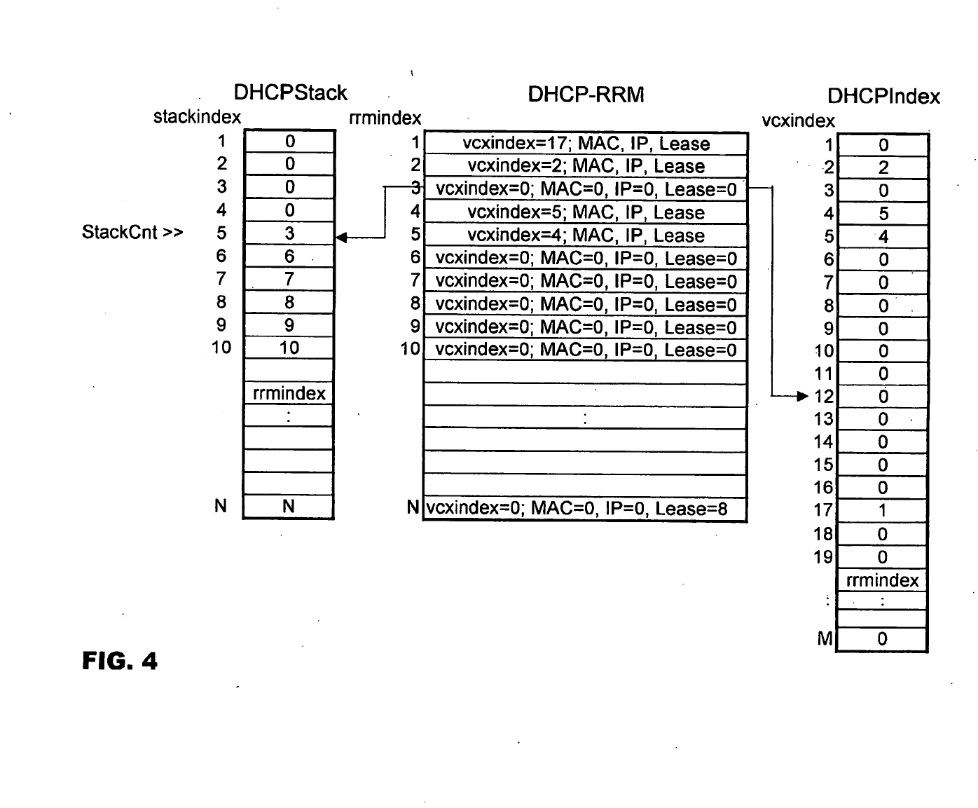

FIG. 4 State of a data structure with subscriber data on the deletion of an expired subscriber data set;

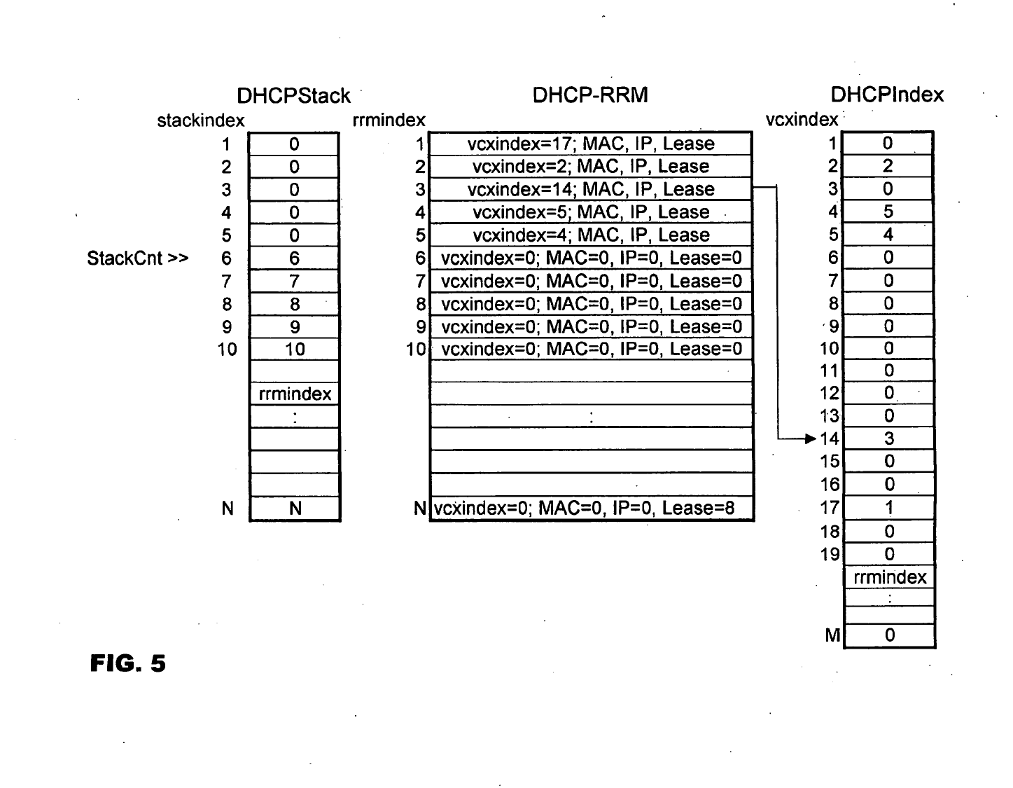

FIG. 5 State of a data structure with subscriber data on the replacement of an expired subscriber data set by a new subscriber data set;

The exemplary embodiment relates to a DSLAM, also known as a DSLAM connection multiplexer or connection multiplexer 1. The invention can however be used for any type of connection technology in which it is intended to manage restart-resistant subscriber data for subscribers 8. As mentioned, FIG. 1 shows the connection of the ADSL subscriber to a telecommunications infrastructure. Only a single subscriber 8 is explicitly represented in the drawing. A detailed explanation now follows. A plurality of ADSL subscribers 8 are connected to a connection multiplexer 1. In the context of this document, said plurality or number is designated by the letter M. In the context of this document, most of the discussion is about subscriber data sets or data sets for short. In a very concise nomenclature it would be necessary to use instead and in every case the expression “subscriber access data set”, but this is simply subsumed into the aforementioned expression subscriber data sets. The connection multiplexer has a processor system which has a read-write RAM in the known way and a restart-resistant memory RRM for the embodiment of the present invention. The restart-resistant memory RRM is dimensioned so that N subscriber data sets can be stored. This is governed by the restriction N>M.

The method will now be explained with the aid of FIGS. 2 to 5. The explanations and definitions listed at the end of this document under the heading “List of the reference characters and variables used” form an integral part.

The sequence in which the subscriber data sets for the number M of subscribers need to be stored is arbitrary. The principle used for the inventive method is the obvious one of “first come first served”. In particular this means that the data sets are stored in as efficient a way as possible without being re-sorted. Aging of the “lease time”, that is to say the time-limited validity of a connection, as explained in the introduction, represents a problem for the further management and/or administration of these data sets. It is also intended that re-sorting shall not be carried out when the validity of a data set expires. Instead it shall be possible for data sets that are no longer valid to be overwritten by a new, current data set.

A restart-resistant memory RRM with a capacity of N data sets is available for storing the restart-resistant subscriber data sets containing a MAC address, an IP address, the period of validity and the allocation to the subscriber concerned (index vcxindex). Information is stored in this memory RRM, with the reference characters DHCP-RRM (see FIGS. 2 to 5), in the sequence in which it occurs. A dynamic memory DHCPStack monitors the occupancy of said memory RRM. This is achieved with the aid of a stack pointer StackCnt that indicates which of the elements in the memory DHCP-RRM is the very next free element. If a data set needs to be stored in the memory DHCP-RRM, the element at the location StackCnt in the memory DHCPStack specifies the next free element in the memory DHCP-RRM. When the data set has been stored, the value zero is written to the location StackCnt. This means that the location concerned in the memory DHCPStack is occupied by a valid entry. The pointer StackCnt is then incremented by 1. From the viewpoint of the numbered/indexed subscribers, a further read-write memory DHCPIndex is provided, of which the location rrmindex in the memory DHCP-RRM contains the data set of the subscriber with connection index vcxindex. In this instance the subscribers are listed in linear fashion. This situation is illustrated in FIG. 3. The occupancy and position of the different indices in the initial state with no data sets stored is shown in FIG. 2.

The removal of a subscriber data set will now be explained with the aid of FIG. 4. FIG. 4 shows an exemplary state with 5 valid data sets. This is arranged to ensure that the vcxindex, MAC address, IP address and lease time are set to an invalid value in the memory DHCP-RRM. Zero coding has been chosen for this purpose. If the period of validity “lease time” expires for a subscriber, the method proceeds as follows.

In the memory DHCPIndex the index rrmindex is read from the location vcxindex. The content of the data set concerned in the memory DHCP-RRM is made invalid by overwriting with zeros in the previously mentioned manner. The stack pointer is decremented by 1 and the value zero(=occupied) in the memory DHCPStack is overwritten with the index rrmindex of the now freed memory location in the memory DHCP-RRM. In the present case according to the figure this information consists of:

rrmindex=3

StackCnt=5

vcxindex=12, being subscriber 12.

FIG. 5 shows the insertion of a new subscriber data set. The starting point here is the situation according to FIG. 4, where there is now a free space at the location rrmindex=3 of the memory DHCP-RRM. The next subscriber data set needing to be stored for the subscriber with vcxindex=14 is now entered as follows.

Zero for occupied was entered at the old location StackCnt=5, then the StackCnt was incremented by 1, now at stackindex=6. By means of a scan from rrmindex=1 onwards a free memory location was found in the memory DHCP-RRM at the location rrmindex=3. The data set for the subscriber 14 is now entered here. The term scan refers to an efficient search of a memory area. Preferably an instruction SCAN_EQUAL or SCAN_NOT_EQUAL, of the type known as a machine-oriented instruction, will be used for this purpose on implementation.

If the connection multiplexer undergoes a restart, the data in the memories DHCPStack and DHCPIndex will be reconstructed as follows:
i) The memory DHCPStack is overwritten with the index; the value stackindex is at the location stackindex.
ii) The memory DHCPIndex is initialized with zero.
iii) The restart-resistant memory is scanned from rrmindex=1 onwards. Each time a valid entry is found—for example non-zero according to the previously described coding—the value 0 is written to the location StackCnt in the memory DHCPStack and the stack pointer StackCnt is then incremented by 1. When a subscriber data set is recognized as valid, the number/index vcxindex is read from it and the index rrmindex of the valid data set concerned is written to the location vcxindex in the memory DHCPIndex. In this way the previously unused state with zero is overwritten with a valid index rrmindex.

On implementation, the restriction N<M makes it essential that cases of failure are detected and accordingly notified by means of overflow buffering routines. Preferably the values for N and M are adjusted to an average traffic volume.

However, the idea behind the invention makes it possible to provide exactly the same number of memory locations for subscriber data sets as the number of subscribers connected to the connection multiplexer 1.

Only the minimum subscriber data that needs to be stored per subscriber connection data record has been listed here.

### LIST OF THE ACRONYMS USED

ADSL Asymmetric DSL
ATM Asynchronous Transfer Mode
ATU-R ADSL Transceiver Unit, Remote (terminal end)
CLU Central Line Unit
DSL Digital Subscriber Line
DSLAM Digital Subscriber Line Access Multiplexer
IP Internet Protocol, used in the context of this document as an abbreviation for IP address
NT Network Termination
MAC Media Access Control
PON Passive Optical Network
RAM Random Access Memory
RRM Restart Resistant Memory
SDH Synchronous Digital Hierarchy
SDSL Symmetric DSL
xDSL Name for different types of DSL transmission technologies such as ADSL, SDSL, etc.

### LIST OF THE REFERENCE CHARACTERS AND VARIABLES USED

1 DSLAM, DSLAM connection multiplexer, connection multiplexer
2 Ethernet or ATM
3 CLU
4 SU
5 xDSL
6 Network termination, splitter
7 Ethernet
8 Personal computer, terminal device, client computer
DHCPStack Dynamic memory for addressing the elements in the restart-resistant memory DHCP-RRM and for determining how much of the memory DHCP-RRM is occupied.
DHCP-RRM Restart-resistant memory containing the subscriber data sets.
DHCPIndex Dynamic memory for addressing the elements in the restart-resistant memory DHCP-RRM from the viewpoint of the numbered/indexed subscribers.
Lease Lease time, period of validity
M Number of (ADSL) subscribers per connection multiplexer
N Number of data sets to be stored in a restart-resistant memory
StackCnt Current memory occupancy, indicator
Stackindex Index for addressing the dynamic memory DHCPStack.
vcxindex Index for addressing the dynamic memory DHCPIndex (from the viewpoint of the numbered/indexed subscribers), elements being assigned to subscribers on a precisely 1:1 basis.
rrmindex Index for addressing the restart-resistant memory containing the subscriber data sets.

### LIST OF REFERENCES

[1] EP 1 260 907 A1, publication date 27.11.2002, “Method of persistent storing of data” Siemens Schweiz AG, 8047 Zurich.
[2] WO 2004/038979 A2, publication date 06.05.2004 “Passive optical network address association recovery” Optical Solutions, Inc. Minneapolis.

1. A method of saving subscriber data from a connection multiplexer in a restart-resistant manner, said data being stored in one subscriber connection data record per subscriber, and containing at least
an electronic address and
a period of validity;
wherein the subscriber connection data records are stored in a restart-resistant memory,
wherein the subscriber connection data record further comprises an index identifying the subscriber concerned;
wherein after a restart of the connection multiplexer the subscriber data is reconstructed by means of the following method steps:
A) determining a number of subscriber data sets and thereby an occupancy of the restart-resistant memory; and
B) allocating individual subscribers, arranged in linear fashion, to their corresponding stored data sets with the aid of an index which is stored in a table and identifies each of the subscribers concerned.

2. The method according to claim 1,
wherein
before the method steps A and B are executed in case of a reconstruction the following steps are performed:
A1) initializing a first dynamic read-write memory by scanning values in ascending numerical order and using a pointer which points to a next free location in the restart-resistant memory via the initialized dynamic read-write memory; and
A2) initializing a second dynamic read-write memory which points to data sets in the numbered sequence of subscribers having a value that does not correspond to any allocation.

3. The method according to claim 2, wherein
invalid data sets in the restart-resistant memory are encoded with a fixed value.

4. The method according to claim 3, wherein
in method step A the number of data sets is determined by scanning the data sets stored in the restart-resistant memory.

5. The method according to claim 2, wherein
in method step B allocation is performed by overwriting a value that does not correspond to any allocation with an index of a data set recognized as valid that is stored in the restart-resistant memory.

6. The method according to claim 1, wherein
a number of subscribers is greater than a number of data sets to be stored, and if a limit of data sets to be stored is reached, routines for overflow buffering and notification are launched.
